(19) United States
(12) Patent Application Publication
(10) Pub. No.: US 2008/0061734 A1
(43) Pub. Date: Mar. 13, 2008

(54) BATTERY PACK, POWER TOOL, AND CHARGER WITH INDUCTIVE COUPLING

(76) Inventors: Heiko Roehm, Stuttgart (DE); Klaus Dengler, Kornwestheim (DE)

Correspondence Address: Striker, Striker & Stenby, 103 East Neck Road, Huntington, NY, 11743, US

(21) Appl. No.: 11/852,404

(22) Filed: Sep. 10, 2007

(30) Foreign Application Priority Data
Sep. 11, 2006 (DE) 102006042602.9

(51) Int. Cl. H02J 7/00

(52) U.S. Cl. 320/108

(57) ABSTRACT

A battery pack that makes a power tool easier to handle has a first element for a detachable mechanical and electrical coupling to a power tool and a second element by way of which an inductive coupling with a charger can be made.

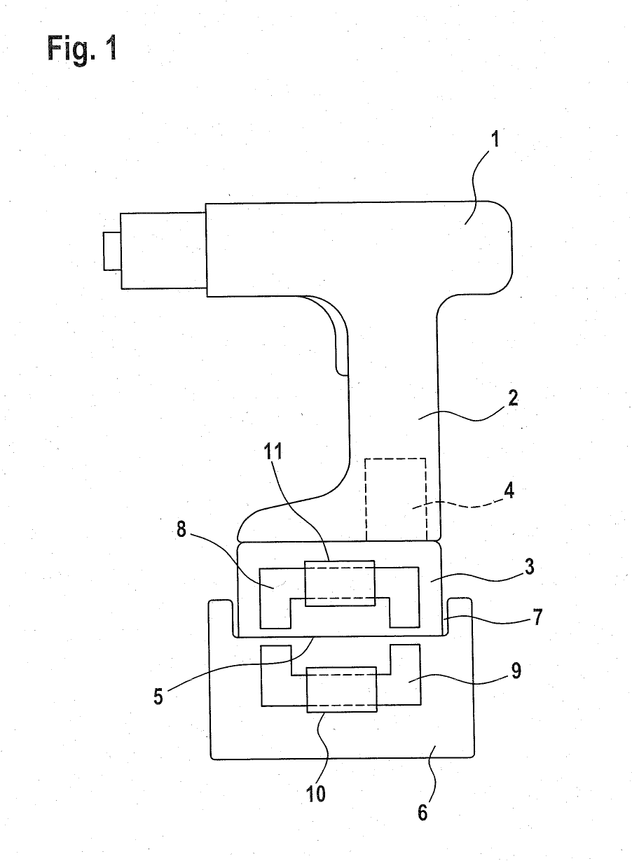

### CROSS-REFERENCE TO A RELATED APPLICATION

The invention described and claimed hereinbelow is also described in German Patent Application DE 102006042602.9 filed on Sep. 11, 2006. This German Patent Application, whose subject matter is incorporated here by reference, provides the basis for a claim of priority of invention under 35 U.S.C. 119(a)-(d).

### BACKGROUND OF THE INVENTION

The invention is based on a rechargeable battery pack, a power tool, and a charger.

As taught for instance by European Patent Disclosure EP 1 076 370 B1, there are power tools—such as power screwdrivers, circular saws, percussion power drills, and hammers—that are supplied with the energy of a battery pack that can be coupled detachably to it both mechanically and electrically. When the battery pack is discharged, it is uncoupled from the power tool and inserted into a charger for recharging. So that the work to be done with the power tool will not have to be interrupted too long during the charging process, a reserve battery pack should be provided, with which the power tool can continue to be operated.

The mechanical and electrical coupling means provided on the battery pack, as disclosed in EP 1 076 370 B1, are embodied for both coupling to the power tool and coupling to the charger. Regardless of whether the battery pack of the prior art described has battery cells that can be charged quickly or slowly, handling in changing the battery pack and recharging is relatively complicated and takes time.

### SUMMARY OF THE INVENTION

It is therefore an object of the present invention to provide a battery pack, a power tool, and a charger, which eliminate the disadvantages of the prior art.

A battery pack of the invention has first means, for detachable mechanical and electrical coupling to a power tool, and second means, by way of which an inductive coupling with a charger can be made.

The coupling to the charger for recharging the battery pack can also be done without detaching the battery pack from the power tool. That is, the same means present for coupling to the power tool are not, as in the prior art cited at the outset, also used for coupling the battery pack to the charger. It thus becomes possible for the entire power tool with the battery pack to be inserted into a charger.

Because of the inductive coupling between the battery pack and the charger, complicated mechanical and electrical coupling structures on the battery pack and on the charger are not needed, either. Thus the charger can advantageously be used as a stand for the power tool together with the battery pack. In intervals between jobs, the power tool can be recharged in the meantime by simply being placed in the charger, without first having to disconnect the battery pack from the power tool. If the battery cells present in the battery pack are Li-ion cells, then it takes only little time to recharge the battery cells.

The means, present in the battery pack, for inductive coupling to a charger advantageously comprise one part of an iron core, belonging to a transformer, that has at least one secondary winding. The complementary part of the iron core, which completes the transformer, is located in the charger and is wound with at least one primary winding. If the battery pack is now inserted into the charger, then an inductive coupling takes place between the two parts of the transformer, resulting in charging of the battery pack.

Locating an iron core in the battery pack has the advantage that by its weight, especially if the battery pack is coupled to the lower end of the handle, for instance of a drill hammer, percussion power drill, or power screwdriver, the center of gravity of the power tool is shifted farther into the handle, which improves the balance of the power tool as it is being used. Moreover, the device with the battery pack coupled to it, because of the shift of the center of gravity downward, has better stability when the device with the battery pack is set down on the bottom face of the battery pack.

The invention also deals with a power tool, comprising a battery pack having first means configured for detachable mechanical and electrical coupling to a power tool; and second means configured for an inductive coupling with a charger.

The invention also deals with a charger inductively coupleable to a battery pack that is mechanically and electrically coupleable to first means of a power tool, said charger being configured for an inductive coupling with second means of the battery pack.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawings is a view showing a battery pack, a power tool and a charger with an inductive coupling in accordance with the present invention.

### DESCRIPTION OF THE PREFERRED EMBODIMENTS

In the drawing, as an example of a power tool, a power screwdriver 1 is shown, to that handle 2 of which the battery pack 3 is coupled in the lower region of the handle. Means for mechanical and electrical detachable coupling between the battery pack 3 and the handle 2 of the power tool 1 are indicated in the drawing by reference numeral 4. No attempt will be made to describe this coupling means 4 in detail, since such coupling means are well known in the prior art, for instance from the reference cited at the outset, EP 1 076 370 B1. These coupling means 4 are designed such that the battery pack 3 can be disconnected from the power tool 1 in order to replace the battery pack with another battery pack.

The side 5 of the battery pack 3 facing away from the handle 2 of the power tool 1 is preferably embodied such that it is suitable as a base for the power tool 1, with the battery pack 3 coupled to the power tool.

For charging the battery pack 3, the power tool 1, together with the battery pack 3 coupled to it, is inserted into a charger 6. However, the battery pack 3 may also be disconnected from the power tool 1 and placed in the charger 6 for charging. The battery pack 3 and the charger 6 are embodied such that the charging of the battery pack 3 is effected via an inductive coupling between the battery pack 3 and the charger 6. For that purpose, there is no need for special electrical contacting means to be present on the battery pack 3 and on the charger 6. The charger 6 merely has a receiving shell 7 for the battery pack 3.

The battery pack 3 may contain NiCd or NiMH or Li-ion cells. Li-ion cells have the advantage that their weight relative to the energy content is less than for other battery types.

The inductive coupling is effected via a transformer, whose iron core is split into two parts. The first part 8 of the iron core is located in the battery pack 3, and the second part 9 of the iron core, complementary to the first part, is disposed in the charger 6. At least one primary winding 10 is applied to the second part 9 of the iron core in the charger 6. The first part 8 of the iron core in the battery pack 3 has at least one secondary winding 11.

If the battery pack 3 is now placed in the receiving shell 7 of the charger 6, an inductive coupling is effected between the primary winding 10 and the secondary winding 11 by way of the two parts 8 and 9 of the iron core of the transformer. With the energy transferred from the primary winding 10 in the charger 6 to the secondary winding 11 in the battery pack 3, the battery cells in the battery pack 3 can then be charged. The electrical triggering of the battery cells and the electronics for regulating charging will not be described in detail here, because versions from the prior art can be used for the purpose.

Because one part 9 of the iron core is accommodated in the battery pack 3, specifically in the vicinity of the base 5 facing away from the handle 2, the weight of the battery pack 3 is increased; consequently the center of gravity of the entire arrangement, comprising the power tool 1 and the battery pack 3, is shifted into the handle 2. This improves the balance of the power tool in use. Moreover, with the battery pack 3 coupled to it, the power tool has greater stability when the power tool 1 is set down on the base 5 of the battery pack 3 in the charger 6 or elsewhere.

The number of windings of the secondary winding 11 in the battery pack 3 is oriented to the number of battery cells; in other words, it depends on the rated voltage of the battery pack 3. The number of windings of the primary winding 10 in the charger 6 is independent of the rated voltage of the battery pack 3. With one and the same charger 6, battery packs having various rated voltages can thus be charged, without requiring an adaptation to the rated voltage of whichever battery pack is to be recharged to be made in the charger by means of an electronic charging system.

It will be understood that each of the elements described above, or two or more together, may also find a useful application in other types of constructions differing from the type described above.

While the invention has been illustrated and described as embodied in a battery pack, power tool, and charger with inductive coupling, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A battery pack, comprising first means configured for detachable mechanical and electrical coupling to a power tool; and second means configured for an inductive coupling with a charger.

2. A battery pack as defined in claim 1, wherein said second means have a part with at least one secondary winding of a transformer of an iron core located in the battery pack so that on being inserted into the charger, it couples inductively with a complementary part of the iron core that is located in the charger and has at least one primary winding.

3. A battery pack as defined in claim 1, wherein said second means configured for an inductive coupling with the charger are located in the battery pack on a side diametrically opposite to said first means configured for coupling to the power tool.

4. A battery pack as defined in claim 1, further comprising a base, said second means configured for an inductive coupling with the charger being located in a vicinity of said base.

5. A power tool, comprising a battery pack having first means configured for detachable mechanical and electrical coupling to a power tool, and second means configured for an inductive coupling with a charger.

6. A power tool as defined in claim 5, wherein said second means configured for an inductive coupling with the charger is configured so that they provide the inductive coupling with the charger without disconnecting the battery pack form the power tool.

7. A power tool as defined in claim 5, further comprising a handle having a lower end, said means configured for detachable mechanical and electrical coupling of the battery pack to the power tool being provided on said lower end of said handle.

8. A charger inductively coupleable to a battery pack that is mechanically and electrically coupleable to first means of a power tool, said charger being configured for an inductive coupling with second means of the battery pack.

9. A charger as defined in claim 8, further comprising one part with at least one primary winding of a transformer of an iron core that upon insertion of the battery pack couples inductively with a complementary part located in the battery pack of the iron core, which complementary part has at least one secondary winding, and said complementary part and said secondary winding form said second means.
